(19) United States
(12) Patent Application Publication
(10) Pub. No.: US 2010/0327246 A1
(43) Pub. Date: Dec. 30, 2010

(54) MODULAR FENCE SYSTEM AND METHOD

(76) Inventor: James W. McKell, Smyma, GA (US)

Correspondence Address: THOMPSON HINE L.L.P.;Intellectual Property Group, P.O. BOX 8801, DAYTON, OH, 45401-8801, US

(21) Appl. No.: 12/822,767

(22) Filed: Jun. 24, 2010

Related U.S. Application Data
(60) Provisional application No. 61/219,810, filed on Jun. 24, 2009.

(51) Int. Cl. E04H 17/10; E04H 17/14; B23P 11/00

(52) U.S. Cl. 256/47; 256/65.01; 29/428; 29/525.11

(57) ABSTRACT

An attractive style fence system and method is presented that can be easily erected and disassembled by one person. The fence is based upon typical posts driven into the ground, where relatively posts are clad or covered by an outer post or shell, that can be in any suitable decorative form, such as a traditional post and rail fence. The outer posts and rails can be made from thermoplastics, increasing durability of the fence, and potentially reusing recycled materials.

### CROSS-REFERENCE TO RELATED APPLICATIONS

This application claims the benefit of U.S. Provisional Patent Ser. No. 61/219,810, entitled, “MODULAR FENCE SYSTEM”, filed on Jun. 24, 2009.

### TECHNICAL FIELD

This application relates generally to systems and methods of fence design and construction.

### BACKGROUND

Fencing systems have been designed with a variety of materials to suit specific needs and applications. Classic post and rail designs are attractive and provide strength to contain livestock as well as resisting breakage. Wire fences are nearly invisible against the landscape and do not require postholes. Both designs have drawbacks and are difficult to erect. Post and rail designs typically use large quantities of lumber and require postholes which are difficult to dig. Furthermore, the posts constructed of most materials either rot or degrade in the soil and need to be replaced. The materials requirements of post and rail designs also limit the density of fence thereby allowing smaller animals or children to breach the fence line between the rails. Wire fences typically provide better containment of children and smaller animals, but are also difficult to erect because the rolls of wire weigh hundreds of pounds and must be stretched. Both designs are difficult for one person to erect and to disassemble. Therefore it is desirable to have a fencing system that incorporates the advantages of each without the drawbacks.

### SUMMARY

In an aspect, a fencing system and method for erecting such fencing system which incorporates post and rail and wire fence components to gain the advantages of both that can be easily erected by one person is presented.

In one embodiment, this system and method utilizes a line post, or T post, with an outer post formed of multiple outer post sections. One or more rails connect the posts together with mortise and tenon joinery. Optional wire fence panels are inserted between the rails. Wire fence panels are small and easy to handle.

In one aspect, natural resources are conserved and waste materials are re-used for other purposes by forming the posts and rails from recyclable materials such as vinyl, nylon carpeting, PVC, plastic bottles and bags and other waste materials instead of lumber. In another aspect, filler materials such as wood fiber and paper mill waste are mixed with polymers. A person of ordinary skill in the art in one aspect forms parts into the final desired or near-final desired shape using a molding or extrusion process or machines the desired parts from solid pieces.

The details of one or more embodiments of system and method for a modular fence system are set forth in the accompanying drawings and the description below. Other features, objects, and advantages will be apparent to a person having ordinary skill in the art from the description and drawings, and from the claims.

### BRIEF DESCRIPTION OF THE DRAWINGS

The claimed subject matter is described with reference to the accompanying drawings. A brief description of each figure is provided below. Elements with the same reference number in each figure indicate identical or functionally similar elements. Additionally, the left-most digit(s) of a reference number indicate the drawing in which the reference number first appears.

FIG. 1 illustrates a front view of typical fence section in accordance with an aspect of the subject matter described herein;

FIG. 2 illustrates an end view detail of a rail section in accordance with an aspect of the subject matter described herein;

FIG. 3 illustrates a top view of a post assembly in accordance with an aspect of the subject matter described herein;

FIG. 4 illustrates a front view detail of post and rail assembly in accordance with an aspect of the subject matter described herein;

FIG. 5 illustrates an exploded top view of post detail in accordance with an aspect of the subject matter described herein;

FIG. 6 illustrates an exploded front view of post detail in accordance with an aspect of the subject matter described herein;

FIG. 7 illustrates a racked wire fence panel in accordance with an aspect of the subject matter described herein;

FIG. 8 illustrates an alternative embodiment utilizing rectilinear posts in accordance with an aspect of the subject matter described herein;

FIG. 8A is a close up view of the interface between two rails in the embodiment of the post assembly shown in FIG. 8 in accordance with an aspect of the subject matter described herein;

FIG. 9 is a flow chart of an exemplary method of erecting the fencing system in accordance with an aspect of the subject matter described herein; and,

FIG. 10 illustrates a top view of another embodiment of a post assembly, wherein the slot is offset in accordance with an aspect of the subject matter described herein;

### DETAILED DESCRIPTION

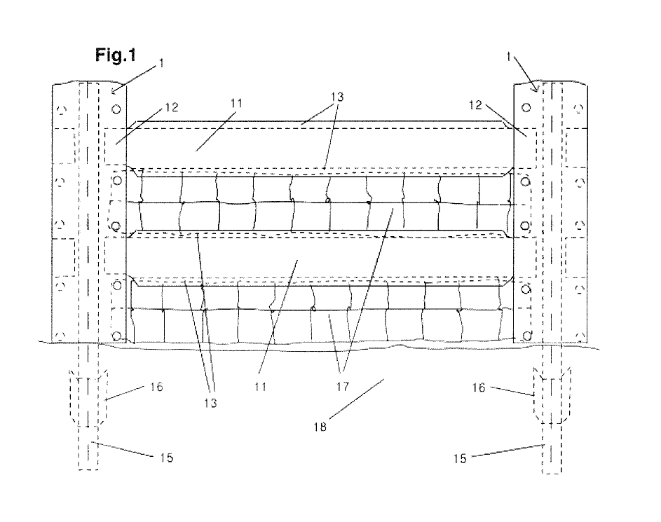

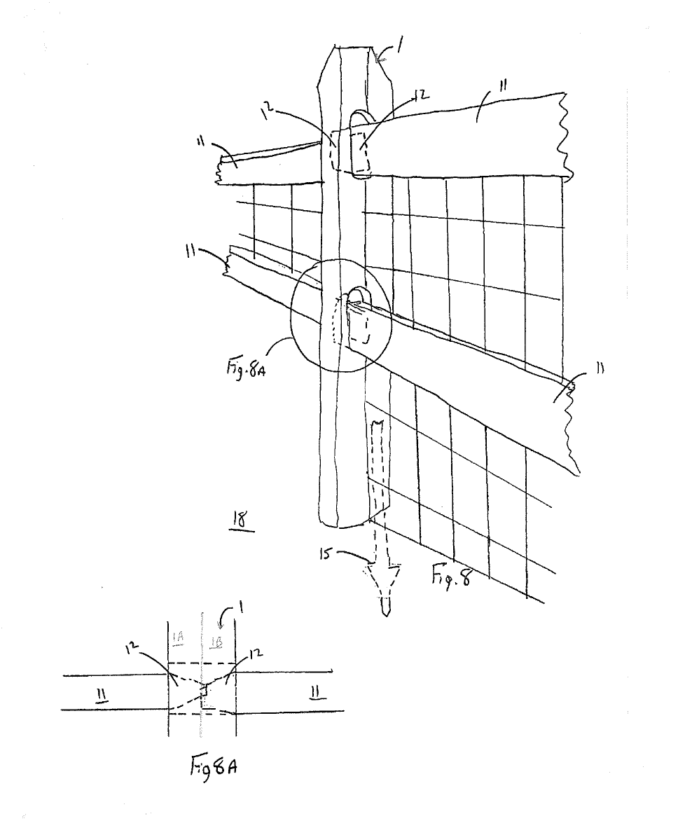

Referring to FIG. 1, an exemplary embodiment of a modular fence system is illustrated. In the depicted embodiment, posts, such as T-posts or line posts 15, are driven into the ground 18 with a sledgehammer, post driver, or any other suitable means of driving posts into the earth. In some embodiments the line posts 15 are formed from angled, tubular, square, or channel profiles as known to those of ordinary skill. These line posts 15 serve as anchors for the modular fence system, securing the system to a fixed location on the ground 18 and providing support for the installed fence. In an embodiment, an outer post 1 encompasses the line post 15. In further embodiments, the outer post 1 is molded from materials such as thermoplastics. In a further embodiment, the outer post 1 is formed in a decorative shape, such as the shape of a split rail fence post. In one aspect, the outer post 1 is shaped to receive a tenon 12 of one or more rails 11. In this manner, one aspect of the present modular fence system is to have an appearance similar to a traditional split rail fence, as shown in FIG. 8, while utilizing modern materials including plastics, potentially increasing durability and providing environmentally friendly fencing. Further the present system and method is readily installed by a single person.

Referring still to FIGS. 8 and 8A and specifically FIG. 8A, it is shown that the mortise 4 passes through the entire outer post 1, from one part of the external surface of the outer post section 1A to the a second part of the external surface of the outer post section 1B. Also shown in FIG. 8, the line post 15 is shown in an alternative embodiment, in this aspect a truncated form where the entire height of the line post 15 is less than the height of the outer post 1.

In further embodiments, the outer posts 1 and rails 11 are made from plastic materials, including waste materials, re-used by forming the posts and rails from recyclable materials such as high-density polyethylene (HDPE), vinyl, nylon carpeting, PVC, plastic bottles and bags and other waste materials instead of lumber. In one aspect the outer posts 1 and rails 11 are formed of a thermoplastic generally. In another aspect the outer posts 1 and rails 11 are formed of a thermoset material. In another aspect, filler materials such as wood fiber and paper mill waste are mixed with these polymer substances. In embodiments, the modular fence system is formed, at least in part, from thermoplastics. Exemplary materials for the outer posts 1 and rails 11 include PVC, polystyrenes, polytetraflouro (PTTE), polyamide, nylon polypropalene, polyurethane, or polycarbonates. In another aspect a curable or epoxy based material is used either separately or in combination with reinforcing materials such as polymer, carbon or glass threads is used to fabricate the outer posts 1 and rails 11. In still another embodiment, the outer posts 1 and rails 11 are fabricated using concrete based products, such as styrofoam filled concrete or expanded polystyrene concrete. As understood by those having ordinary skill the outer posts 1 and rails 11 in some aspects are optionally fabricated from dissimilar materials.

In one aspect, outer posts 1 and rails 11 are formed into the final desired or near-final desired shape during a molding or extrusion process or machined from solid pieces. In other aspects the outer posts 1 and rails 11 are formed in part using a molding or extruding process and then finished to final form using secondary machining and surface treatment processes. The molding process is selected by one having ordinary skill from those processes known such as injection molding, extrusion molding, flat or pour molding, or any other suitable molding process to form the outer post and rail pieces. In one embodiment portions of the rails 11 and/or the outer posts 1 are formed using an extrusion process. In another embodiment the rails 11 and/or the outer posts 1 are formed using a co-molding or co-extrusion process whereby one plastic is used for a first section and another is used for a second section of the mold. In one aspect of such an embodiment the core is formed of a first section of relatively lower cost polymer materials while the second section that is overmolded over the 1st section comprises a material with enhanced environmental protection. In one aspect the polymer that forms the outer surface of the outer posts 1 and rails 11, is resistant to UV exposure. In another aspect the outer surface of the outer posts 1 and rails 11 are formed of a polymer with specific weather resistance. In another aspect the outer surface of the outer posts 1 and rails 11 are coated after fabrication to increase weather resistance.

In another embodiment, the modular fence system includes one or more wire fence panels 17. Such wire fence panels 17 are optionally installed between rails 11 as well as below the bottom most rail 11. In an embodiment, a wire fence panel 17 is generally rectangular in shape and formed from intersecting wires. As shown in FIG. 1, the wire may be arranged to form squares; however, a person having ordinary skill may select alternative patterns. Wire fence panels 17 can be formed by twist wrapping the intersecting wires or by welds. The inclusion of wire fence panels 17 allow the modular fence system to be used to contain smaller animals; while still appearing relatively open. In addition, wire fence panels 17 can be sized so as to be relatively easily handled by a single individual. In another aspect the wire fence panels 17 that are used below the lower-most rail 11 of a given fence section include a stiffening bar that is threaded through the wires of the wire fence panel that are closest to the ground 18.

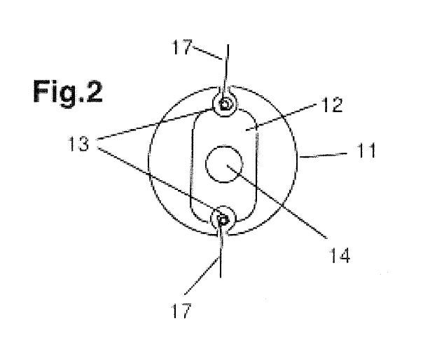

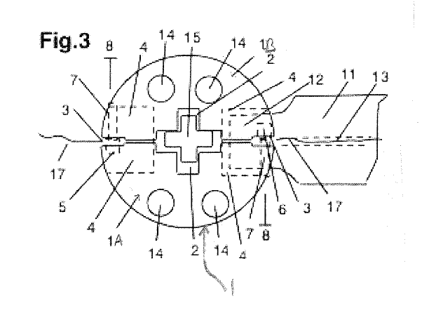

Referring to FIG. 2, in embodiments, a tenon 12 is formed at both ends of each rail 11. In one aspect the tenon 12 has a rectangular shape. In this aspect the rectangular shape of the tenon 12 prevents the rail 11 from turning in a mortise 4 of the outer post 1, also seen in FIGS. 3-6. In a further embodiment, keyed slots 13 are formed along the top and bottom edges of each rail 11 to allow wire fence panels 17 to slide into the rail 11. Alternatively, the slot 13 need not be keyed. A straight slot, groove or channel can also be formed in one or both sides of the rail in order to accept the wire fence panel 17. In another embodiment the wire fence panel 17 is secured to the rail 11 using a series of integral or removable clips, such as spline clips or locking clips. In one aspect the clips that secure the wire fence panel 17 to the rail 11 are attached to the rail via a pressure file within the slot 13. In one embodiment the rail 11 is formed with a void or hollow section 14 (shown in FIG. 2) that is formed along the length of the rail 11 to save material in the molding process and to reduce weight. In another embodiment the rail 11 is comprised of a composite structure formed via overmolding or co-molding where the void 14 depicted in FIG. 2 is instead filled with a stiffener, such as a rod, that provides additional rigidity to the rail 11.

In another embodiment, not shown in the figures, the wire fence panel 17 is attached directly to the line post 15 prior to installation of the outer post sections 1A and 1B. In this manner the outer post sections 1A and 1B are assembled to form the outer post 1 and the wire fence panel 17 passes between the outer post sections 1A and 1B.

In a further embodiment, the rail 11 is substantially hollow, or even composed of two separate components, referred to as rail sections that are joined to create a rail shell. In an embodiment, each rail section is molded using a flat mold process. Rail sections can be mated to form a rail shell, which appears similar to a solid rail, but is substantially hollow. Such a rail shell would be lighter. In one aspect the rail shell is affixed to an internal rod that provides additional rigidity to the structure. In one aspect, the use of a generally hollow rail, or rail shell, minimizes the potential for distortion or wear on a rail due to heat from the sun shining on a side of a rail, heating the rail unevenly.

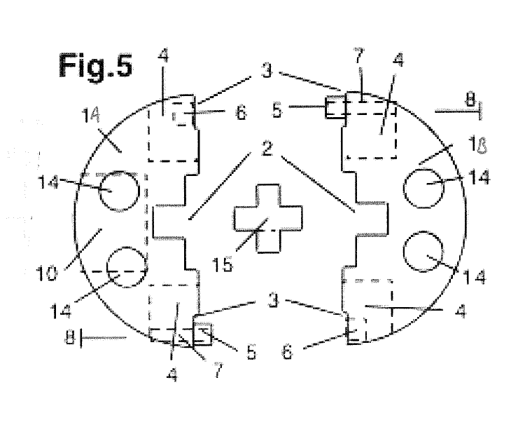

Referring to FIGS. 3 and 5, in embodiments, two substantially similar outer post sections 1A and 1B are mated together to form the outer post 1 around line post 15. The outer post 1 contains slots 2 formed to allow the outer post 1 to capture line post 15. As shown in FIG. 3, in one embodiment the slot 2 formed on the inner surface of the outer post section 1A is shaped to capture the particular shape of the line post 15. When both outer post sections 1A and 1B of the outer post 1 are brought together their inner surfaces form a recess that is generally shaped to accept the outer portion of the line post 15. In the illustrated example, the slot 2 is generally shaped as a cross, or plus, such that once the outer post 1 is positioned with the post 15 rotation of the outer post 1 around the line post 15 is limited. In the embodiment depicted in FIG. 3 the tolerance between the inner surface of the outer post sections 1A and 1B that form the slot 2 in the outer post 1 and the line post 15 is a loose fit. In other embodiments, not depicted, the tolerance could be a slip fit or a press fit where the outer post sections 1A and 1B are compressing the line post 15 with their respective inner surfaces when they are secured together. In still another embodiment the line post 15 is driven further into the ground after it is in contact with the outer post sections 1A and 1B and the movement of the line post 15 against the inner surface of the outer post sections 1A and 1B secures the outer post sections 1A and 1B to the line post 15. In still another aspect the line post 15 is fabricated from a tubular profile, in such case the slot 2 formed by the mating inner surfaces of the outer post sections 1A and 1B does not prevent the outer post 1 from rotating around the line post 15 without the use of a secondary fastener or lock structure such as a set screw or locking post that passes both through a portion of the outer post 1 and the tubular profile line post 15. In still another aspect the outer post 1 is formed of additional outer post sections, in one exemplary embodiment the outer post 1 is formed from three outer post sections that when joined together form the outer post 1. In another exemplary embodiment, the outer post 1 is formed from four outer post sections, where each such outer post section occupies a quadrant of the outer post 1. As can be appreciated by those having ordinary skill in the art, the number of outer post sections used to form the outer post 1 is variable and furthermore the relative size of the outer post sections do not need to be equivalent—e.g. each outer post section could for example correspond to a different areas that are not symmetrical about the center line of the outer post 1.

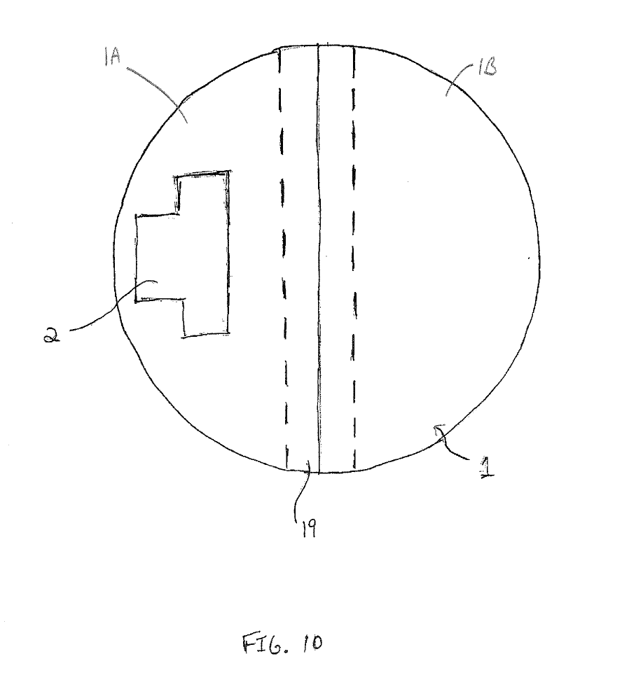

In the embodiment shown in FIGS. 3 and 5, the outer post 1 is optionally installed on a line post 15 in any of four positions relative to the line post 15: zero degrees, 90 degrees, 180 degrees, or 270 degrees. This allows the line post 15 to be driven into the ground at any of these rotations to take advantage of lateral stability provided by flange 16 (shown in FIG. 1). In an additional aspect, the outer post 1 can be rotated as well around line post 15 to form a corner for the fence system. In other embodiments, an additional one or more mortise 10 are formed in the outer post 1 to create a corner post. In the example illustrated in FIG. 10, the slot 2 is shaped so as to receive a U-shaped line post 15. The slot 2 can be shaped so as to capture or receive a line post 15 of various shapes such as angle or box profiles or other profiles known to those of ordinary skill in the art. In another aspect the mortise 4 are shaped with sufficient tolerance with respect to the rail 11 tenon 12 to allow the rail 11 to be angled off normal, i.e. off the perpendicular from the centerline of the outer post 1. In this manner it is possible to structure the modular fence sections to form a curving structure.

As shown in FIG. 5, the slot 2 of the outer post 1 is formed by one or more grooves or notches in the outer post sections 1A and 1B. In an embodiment, rabbets 3 or slots for wire paneling are formed along outer post sections 1 and can be used to seat the edge of the wire fence panels 17. In one embodiment the wire fence panel 17 is tensioned manually between the two outer posts 1. In the illustrated embodiment, mortises 6 and tenons 5 are formed in rabbet 3 and mate to align outer post sections 1 and also to secure the edge of the wire fence panels 17. Wire fence panels 17 are looped around tenons 5 securing the ends of the wire fence panel 17. In an embodiment, a counter bore 7 allows outer post sections 1A and 1B to be secured to each other with screws 8. In other embodiments, grooves or notches in the outer post sections 1 form mortises 4 to accept rail tenons 12. In some embodiments, rail mortises 4 are oversized to allow some adjustment vertically for uneven terrain and horizontally for creating a curved fence line. In other embodiments, optional voids or hollow sections 14 can be formed within the outer post sections 1 to save material in the molding process and to reduce weight.

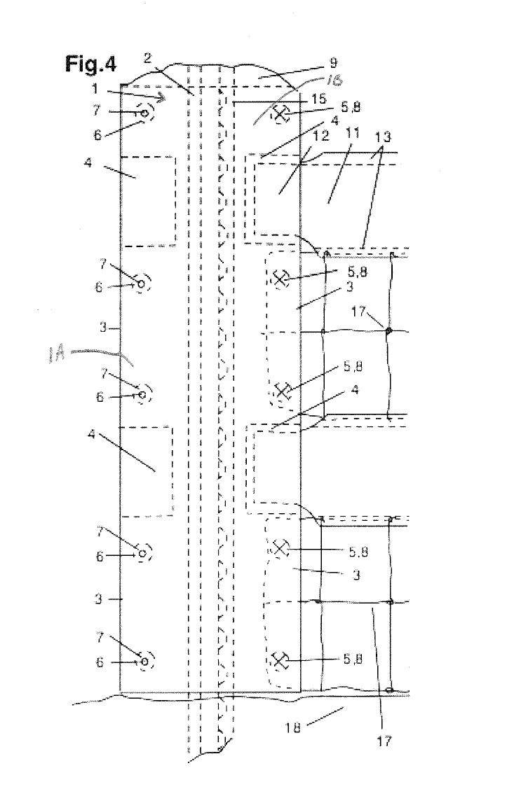

FIG. 4 shows a front view of an embodiment of the modular fence system assembly, relative to FIG. 3. The presented embodiment shows an outer post section 1 with a two rail system; however, any number of rails 11 and wire fence panels 17 may be utilized. As shown, the wire fence panels 17 are secured within the outer post at each end of the rail 11. In addition, the edges of the wire fence panel 17 are also seated within the slots of the rail 11. In the depicted embodiment, all four edges of the wire fence panel are secured to either the outer post or the rail, reducing the potential for bending or distortion of the panel that could result in a hole or breach of the fence line.

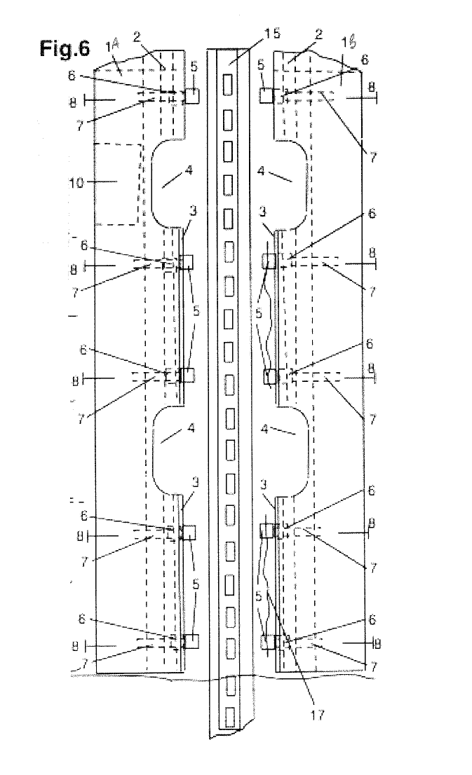

FIG. 6 shows an edge view of an embodiment of a two rail system assembly relative to FIG. 5. FIG. 6 shows separation between the outer post sections 1A and 1B. In an assembled modular fence system, the outer post sections 1A and 1B. are secured to each other forming a the outer post 1.

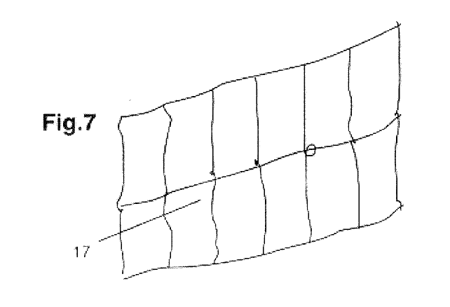

FIG. 7 shows how the wire fence panel 17 can be bent or racked to allow the fence to be installed on sloping or uneven terrain. The inherent flexibility of wire materials allow the wire fence panel 17 to be shaped to conform with the line of the installed fence along the ground 18. In embodiments where the wire fence panel 17 is attached to the outer posts 1 as well as seated in the rail slots 13, the wire fence panel 17 will necessarily follow the shape of the rails 11 and position of the outer posts 1, reducing the potential for gaps in the modular fence system. In another embodiment, not depicted, the wire fence panel 17 is further secured to the ground 18 via tie downs or small posts that capture a small section of the wire fence panel 17 in the tie down or against the ground to further enhance the strength of the barrier and further minimize the ability for smaller animals to pass under the wire fence panel 17 along the ground 18.

In an embodiment, a section of the modular fence system is comprised of five pieces: the outer post 1, the rail section 11, the T-post or line post 15, the optional wire fence panel 17, and the fasteners or screws 8. The fence can have any number of rails 11. Traditionally, two or three rails 11 have been the most popular, with as many as five. At least one rail 11 at the top is required to keep the wire panels 17 stretched tightly. The fence can be erected with outer post 1 and line post 15 with rails 11 only and without the wire fence panels 17. The wire fence panels 17 can be added at a later time by unscrewing 8 the outer post sections 1A and 1B and sliding the wire fence panels 17 into keyed slots 13 on the rails 11.

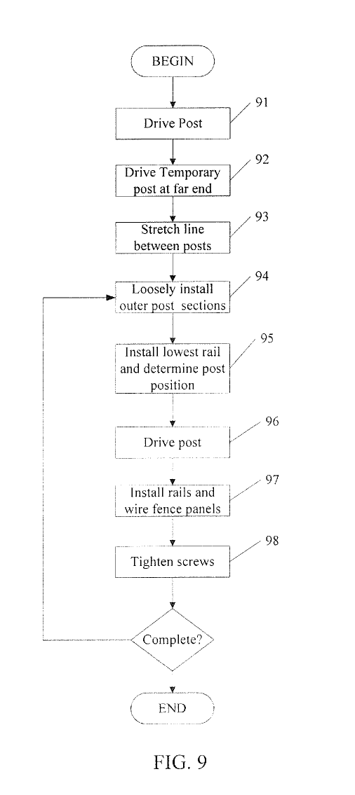

In view of the exemplary systems described supra, methodologies that may be implemented in accordance with the disclosed subject matter will be better appreciated with reference to the flow chart of FIG. 9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter

FIG. 9 is a flow chart of an exemplary method of erecting the fencing system by one person: A reference number 91, using a sledge hammer or line post driver, an installer will drive a first line post 15 at one end or corner of the plot which is to be fenced, preferably making sure the line post 15 is plumb. Generally, a level or plumb bob is used to check plumb. In an embodiment, the installer should leave a portion of the line post 15 extending above the height of the outer post section 1A and 1B. At reference number 92, the installer will drive a second, temporary line post 15 at the far end of the fence run. Next, the installer stretches a string or line tightly between the two line posts 15 just above the ground 18 at step 93. At step 94, outer post sections 1A and 1B are loosely installed around first line post 15. The outer post sections 1 are held in place with screws 8, but the screws 8 are not tightened. Outer post sections 1A and 1B are also loosely installed around a third line post 15. At step 95, the installer will temporarily install a rail 11 between the first and third outer posts 1 in the lowest mortise 4. Based upon this configuration, the installer is able to identify the exact location along the string line to drive the third line post 15. Next at step 96, the installer drives the line post 15 with a hammer, at the location. The installer may leave the outer post 1 seated on the line post 15 to avoid losing the particular spot at which the third post is to be driven. Once the line post 15 is partially driven, the installer can remove the outer post sections 1 and continue to drive the third line post 15 until the top is flush or below the level of the outer post sections 1. At step 97, the rails 11 and wire fence panels 17 are installed into mortises 4 and the ends of the wire fence panel 17 are looped around tenons 5. At this time, in one embodiment the installer may elect to drive a screw 8 through tenons 12 into one of the outer post sections 1. At step 98 the screws 8 on the first post are tightened while the screws 8 on the second post 1 are left loose. If the fence is complete, the process ends there; however, if there are additional sections of fence to install, the process returns to step 95, where outer post sections 1 are loosely installed on a new line post 15, and the bottom rail 11 for the next section of fence is temporarily installed to determine the location of the next line post 15. Screws 8 are tightened as the installer moves down the fence line. The process is repeated until all fence sections are completed.

In another embodiment, alternative fasteners and joining structures are used to fasten the outer post 1 sections together. In one aspect the outer post sections 1 are attached using a keyed-slot where one outer post section 1 has a keyed channel and another outer post section 1 has a slot adapted to accept the keyed channel. The keyed channel and mating slot may in one aspect extend the length of the outer post sections 1, in another aspect the keyed channel and mating slot are interrupted allowing the outer post sections 1 to be displaced only a short distance prior allowing the sections to be joined.

As depicted in FIGS. 4 and 6, embodiments of the modular fence system include a cap 9 positioned on the top of the outer post 1. The cap 9 may be formed by portions of the outer post sections, such that the slot 2 in the outer post 1 does not extend completely through the outer post 1, but rather end proximate to the top of the outer post. The cap 9 hides the top of the T-post 15 and creates a more natural appearance. In addition, the cap reduces the potentia for water or debris to accumulate within the outer post 1. In other embodiments, the cap 9 is separate, and is installed on the top of the outer post section 1. This configuration allows for removal of the cap 9. In another embodiment, the cap 9 includes a tenon, shaped to fit within the slot 2 of the outer post 1.

The outer post sections 1 and the rails 11 can be of any shape on the exterior. They can be round, square, rectangular, oval, or sculpted to mimic natural logs or rough hewn or split rail style. Outer post sections 1 and rails 11 can be produced from the same mold to simplify the manufacturing process or several different shapes of rails 11 and outer post sections 1 could be produced to give a more natural and random appearance. The different shapes of rails 11 can be rotated horizontally and vertically to enhance the effect. The outer post 1 and rail 11 materials can be colored to mimic natural timbers or a painted surface by mixing colorants during the molding process.

In an alternative embodiment, the outer post sections 1 could be formed as separate and distinct parts by placing all mortises 6 on one piece and all tenons 5 on the other mating piece. This would allow all screw holes (counter bores 7) to be on one side of the fence or the other. Counter bores 7 could be plugged or capped for appearance.

FIG. 10 is a top of a further embodiment in which the slot 2 is offset within the outer post 1. In this configuration, the mortise 4 passes completely through the body of the outer post. The post 15 does not interfere with this pass-through mortise 4, because it is offset. As shown in FIG. 10, the slot 2 is formed in one of the outer post sections. With this configuration, only one of the outer post sections need include the slot 2, as shown in FIG. 10. However, each outer section can include a slot 2, either to provide additional flexibility in placement, or simply to reduce materials utilized in the manufacture of outer sections. Although the figures included herein generally depict the outer post sections as forming two substantially similar halves of the outer post, in the other embodiments, the outer sections may distinct in shape and size.

A major advantage of the system and method for modular fence system presented herein is the ability to erect and disassemble a fence by one person. A standard 100′ roll of wire fence weighs over 100 pounds. A 300′ roll weighs over 300 pounds. This makes it very difficult to handle. In this embodiment, individual wire panels are formed to fit between the rails and posts. These panels weigh only a few pounds each, and can be shipped flat in bundles. The standard popular spacing between posts is about 8 feet. The popular standard height of this style of fencing is typically between 3½ feet and 6 feet above the ground. Therefore, the wire panels need only be 2 feet by 8 feet for a two rail system, and 1 foot by 8 feet for a three rail system.

In another embodiment, the outer post sections 1 could be formed as separate and different parts and the rail 11 is also made of two rail halves which can be clamped by deck screws or held in place by any other type of fastener. Connecting the two rails 11 creates a void or hollow section to save material in the molding process and to reduce weight. The rail can be made of two parts in order to avoid the eventual sag and or bending that is usually present in a solid rail constructed of composite plastic and wood. This embodiment also allows for a simpler way of adding the wire fence panel 17. Wire fence panel 17 can be clamped in between the rail halves.

It is to be clearly understood that the above description is intended by way of illustration and example only and is not intended to be taken by way of limitation, and that changes and modifications are possible. Accordingly, other embodiments are contemplated and modifications and changes could be made without departing from the scope of this application.

What is claimed is:

1. A modular fence system for installation on a line post with a first end installed in the ground and a second end exposed above the ground, comprising:
a first outer post section comprising an inner surface;
a second outer post section comprising an inner surface;
an outer post comprising said first outer post section and said second outer post section, with said first outer post section and said second outer post section are joined on respective said inner surfaces and adapted to be seated over the second end of the line post;
a rail mortise defined at least in part by said first outer post section; and,
a rail comprising a rail tenon where said rail tenon is adapted to be inserted into said rail mortise.

2. A system of claim 1, where said rail mortise is defined by both said first outer post section and said second outer post section.

3. A system of claim 1, where said rail mortise is defined entirely by said first outer post section.

4. A system of claim 1, said rail further comprises a rail slot adapted to receive an edge of a wire panel adapted to be mounted to said rail.

5. A system of claim 4, said outer post further comprises a means for attaching a portion of said wire panel.

6. A system of claim 4, further comprising:
a second rail mortise defined at least in part by said first outer post second;
a second rail comprising a second rail tenon, where said second rail tenon is adapted to be inserted into said rail mortise, and a second rail slot adapted to receive a second edge of said wire panel adapted to be mounted between said rail and said second rail.

7. A system of claim 1, where said inner surfaces of both said first post section and said second post section further comprise a mating pair of a post tenon and a post mortise adapted to physically constrain said first post section to said second post section.

8. A system of claim 7, where said first post section and said second post section further comprise a through hole fastener adapted to compress said first post section against said second post section.

9. A system of claim 7, wherein said outer post further comprises a means to fasten said outer post to the line post.

10. A system of claim 1, wherein said rail comprises:
a first rail portion comprising a first mating surface;
a second rail portion comprising a second mating surface; and,
a means for fastening said first rail portion to said second rail portion such that said first mating surface is adjacent to said second mating surface.

11. A system of claim 1, wherein said rail comprises a polymer outer surface surrounding an inner reinforcement wherein said rail tenon is a part of said inner reinforcement.

12. A system of claim 1, further comprising a cap affixed to a top of said outer post.

13. A modular fence system comprising:
a first outer post section comprising a first inner surface and a first outer surface;
a second outer post section comprising a second inner surface and a second outer surface;
an outer post comprising said first outer post section and said second outer post section where said first outer post section and said second outer post section are joined together via said first inner surface and said second inner surface, such that an aperture is formed by said first inner surface and said second inner surface that is adapted to capture a line post;
a rail mortise formed in said outer post;
a rail comprising a tenon adapted to be seated in said mortise; and,
a means for fastening said first outer post section to said second outer post section.

14. A system of claim 13, wherein said aperture is displaced from the center line of the outer post.

15. A system of claim 14, where said rail mortise passes in a transverse direction through the outer post forming a passage between said first outer surface to said second outer surface.

16. A system of claim 13, where said outer post further comprises a rail slot adapted to receive an end of a wire fence panel.

17. A system of claim 16, where said rail further comprises a rail slot adapted to receive an end of a wire fence panel.

18. A method of assembling a modular fence system comprising:
driving a first end of a line post into the ground such that a second end is exposed above the ground;
fitting a first inner surface of a first outer post section against said line post;
fitting a second inner surface of a second outer post section against said line post such that said second inner surface is facing said first inner surface;
affixing said first outer post section to said second outer post section to form an outer post such that a rail mortise is defined on the surface of said outer post;
inserting a rail tenon that is part of a rail into said rail mortise; and,
securing said first outer post section to said second outer post section.

19. A method of claim 18 wherein said step of securing said first outer post section and said second outer post section comprises tightening a threaded fastener.

20. A method of claim 18 further comprising after said step of affixing said first outer post section to said second outer post section, a step of urging said line post further into the ground so said rail mortise is the proper height above the ground after said urging.
